(19) United States
(12) Patent Application Publication
(10) Pub. No.: US 2025/0298551 A1
(43) Pub. Date: Sep. 25, 2025

(54) NON-TRANSITORY COMPUTER-READABLE STORAGE MEDIUM STORING PRINTING CONTROL PROGRAM, PRINTING SYSTEM, AND PRINTED MATTER PRODUCTION METHOD

(71) Applicant: SEIKO EPSON CORPORATION, Tokyo (JP)

(72) Inventor: Masatsugu INOUE, Shiojiri (JP)

(21) Appl. No.: 19/084,833

(22) Filed: Mar. 20, 2025

(30) Foreign Application Priority Data
Mar. 22, 2024 (JP) 2024-046159

(51) Int. Cl. G06F 3/12

(52) U.S. Cl. CPC G06F 3/1206; G06F 3/1228

(57) ABSTRACT

A non-transitory computer-readable storage medium storing a printing control program according to one aspect of the present disclosure causes a computer to perform acquisition processing, difference processing, and first instruction processing. In the acquisition processing, printing data is acquired from a general-purpose printer driver 16. In the difference processing, difference data between first printing data that is previously acquired printing data and second printing data that is newly acquired printing data is calculated. In the first instruction processing, the difference data is transmitted to a printer, and the printer is caused to perform printing based on synthesized data obtained by synthesizing the first printing data with the difference data.

The present application is based on, and claims priority from JP Application Serial Number 2024-046159, filed Mar. 22, 2024, the disclosure of which is hereby incorporated by reference herein in its entirety.

### BACKGROUND

### 1. Technical Field

The present disclosure relates to a non-transitory computer-readable storage medium storing a printing control program, a printing system, and a printed matter production method.

### 2. Related Art

JP-A-2021-56754 discloses a technique for causing a printer to perform booklet printing in an information processing device including an operating system (OS) standard printer driver, which is an OS standard printing program.

Incidentally, printing processing using an image difference to reduce an amount of data transmitted to the printer cannot be said to be general-purpose processing, and is not supported by a general-purpose printer driver such as the OS standard printer driver. Therefore, it is desirable to develop a technique for enabling reduction of an amount of data transmitted to a printer by using an image difference to perform printing in an environment in which printing processing using a general-purpose printer driver is performed.

### SUMMARY

A non-transitory computer-readable storage medium according to one aspect of the present disclosure stores a printing control program, and the printing control program causes a computer to execute: acquisition processing of acquiring printing data from a general-purpose printer driver; difference processing of calculating difference data between first printing data that is previously acquired printing data and second printing data that is newly acquired printing data; and first instruction processing of transmitting the difference data to a printer and causing the printer to perform printing based on synthesized data obtained by synthesizing the first printing data with the difference data.

A printing system according to one aspect of the present disclosure includes: a printer; and a terminal device, in which the terminal device includes a general-purpose printer driver, an acquisition processing unit configured to acquire printing data from the general-purpose printer driver, a difference processing unit configured to calculate difference data between first printing data that is previously acquired printing data and second printing data that is newly acquired printing data, and an instruction processing unit configured to transmit the difference data to the printer and cause the printer to perform printing based on synthesized data obtained by synthesizing the first printing data with the difference data.

A printed matter production method according to one aspect of the present disclosure includes: acquisition processing of acquiring printing data from a general-purpose printer driver; difference processing of calculating difference data between first printing data that is previously acquired printing data and second printing data that is newly acquired printing data; and printing processing of transmitting the difference data to a printer and performing, by the printer, printing based on synthesized data obtained by synthesizing the first printing data with the difference data to produce a printed matter.

### BRIEF DESCRIPTION OF THE DRAWINGS

FIG. 1 is a block diagram illustrating a

configuration example of a printing system according to an embodiment.

FIG. 2 is a sequence diagram illustrating an example of generation processing in the printing system in FIG. 1.

FIG. 3 is a sequence diagram illustrating a first example of low-data-amount printing processing in the printing system in FIG. 1.

FIG. 4 is a diagram illustrating an example of a user interface image displayed in the low-data-amount printing processing in FIG. 3.

FIG. 5 is a schematic diagram illustrating an example of difference processing in the low-data-amount printing processing in FIG. 3.

FIG. 6 is a flowchart illustrating a second example of the low-data-amount printing processing in the printing system in FIG. 1.

FIG. 7 is a diagram illustrating an example of a hardware configuration of a device.

### DESCRIPTION OF EMBODIMENTS

Hereinafter, an embodiment according to the present disclosure will be described with reference to the drawings. The drawings are merely an example illustrating the embodiment of the present disclosure. Not all components described in the embodiment of the present disclosure are essential components of the present disclosure.

### Embodiment

### Configuration of System

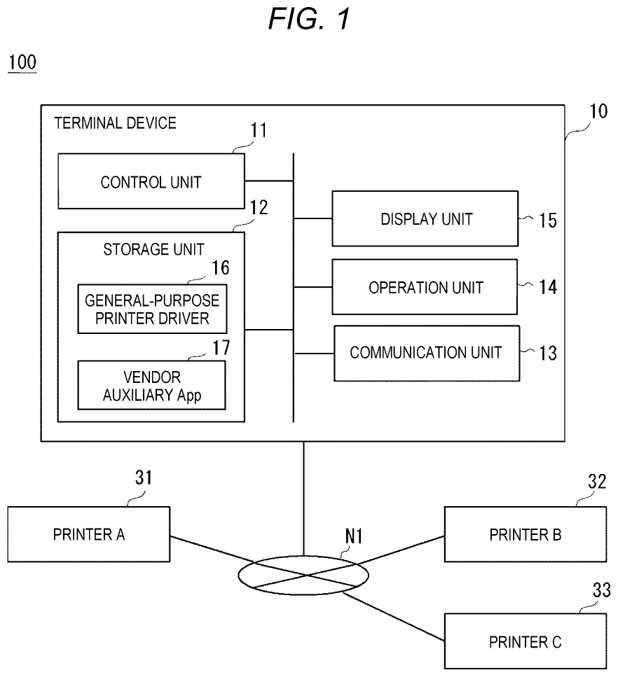

A configuration example of a printing system according to the embodiment will be described with reference to FIG. 1. FIG. 1 is a block diagram illustrating the configuration example of the printing system according to the embodiment.

As illustrated in FIG. 1, a printing system 100 according to the embodiment can include a terminal device 10, a printer A (31), a printer B (32), and a printer C (33).

The terminal device 10 is an information processing device having a communication function, such as a personal computer (PC), a smartphone, or a tablet terminal, and can be used by a user who desires printing. The terminal device 10 may be a portable information processing device or an installation-type information processing device. The terminal device 10 can be connected to the printer A (31), the printer B (32), and the printer C (33) via a network N1. Although not illustrated, the printing system 100 can include a plurality of the terminal devices 10.

All of the printer A (31), the printer B (32), and the printer C (33) are examples of a printer and can print printing data on a medium when receiving the printing data. Each of the printers produces a printed matter by performing printing in this way. For convenience, the description is made on an assumption that the printing system 100 includes three printers as described above. However, a plurality of printers may be included. Each of the printers can also be referred to as a printing device or an image formation device. A printing method in each of the printers does not matter, and various printing methods such as an inkjet printing method or a laser printing method can be applied. The printers included in the printing system 100 may have the same model or different models.

Each of the printers may be a device having a printing function and a communication function, or may be a multifunction device having such as a scanner function, a copy function, and a facsimile transmission function.

The terminal device 10 can issue a printing instruction to a printer selected by a user operation from among printers registered and recognized as a printer that performs printing among the printer A (31), the printer B (32), and the printer C (33). In the following description, an example is described in which all of the printer A (31), the printer B (32), and the printer C (33) are registered and recognized as a printer that performs printing in the terminal device 10.

Hereinafter, a configuration example of the terminal device 10 will be described in detail. Description of a configuration example of each of the printers will be omitted.

### Configuration of Terminal Device 10

As illustrated in FIG. 1, the terminal device 10 can include a control unit 11, a storage unit 12, a communication unit 13, an operation unit 14, and a display unit 15.

The control unit 11 controls the entire terminal device 10. The control unit 11 can include, for example, an arithmetic processing device, a working memory, and a storage device that stores a control program, parameters, and the like. The above-described arithmetic processing device can be a central processing unit (CPU), a graphics processing unit (GPU), or the like. The control unit 11 can also be implemented as a system on a chip (SoC). As can be seen from these examples, the control unit 11 can store the control program in an executable state. The control unit 11 may have a configuration in which a part of the control program is stored as a circuit configuration such as a field-programmable gate array (FPGA), or may be implemented as a dedicated circuit.

The above-described control program can include a program for the arithmetic processing device to execute processing related to printing in cooperation with the storage unit 12, the communication unit 13, the operation unit 14, and the display unit 15. The above-described control program can include an OS. Since the OS is an OS mounted on the terminal device 10, a type of the OS depends on a model of the terminal device 10. The above-described control program can include a Web browser in the OS or outside the OS. In the following description, an example is described in which at least a part of the control program is stored in the storage unit 12 provided separately from the control unit 11. The storage unit 12 may be a part of a storage device in the control unit 11. That is, the storage unit 12 can be grasped as a part of the control unit 11.

The storage unit 12 is, for example, a storage device implemented by a hard disk drive, a solid state drive, or another memory. The storage unit 12 stores, as a part of the control program, a general-purpose printer driver 16 and a vendor auxiliary application program 17 to be described later in a state executable by the control unit 11. Hereinafter, the vendor auxiliary application program will be abbreviated as a vendor auxiliary App. The storage unit 12 can store various types of data such as a printing target file.

The communication unit 13 is a part for communicating wirelessly or wired with external devices such as the printers via the network N1 according to various mobile communication standards or predetermined communication standards such as the Wi-Fi (registered trademark, the same applies below) standard. The communication unit 13 can be implemented by one or a plurality of communication interfaces enabling such communications. The network N1 is usually a local area network (LAN). The communication interface is, for example, an antenna or a cable connector.

The operation unit 14 is a part for receiving operations of the user of the terminal device 10 and can also be referred to as an operation reception unit. The operation unit 14 can be implemented by, for example, one or more of a physical button, a touch panel mounted on the display unit 15, a pointing device, and a keyboard. In a configuration in which the operation unit 14 includes a touch panel, the display unit 15 and the touch panel can be collectively referred to as an operation panel of the terminal device 10.

The display unit 15 is a part for displaying a user interface (UI) image for operating the terminal device 10 and is implemented by a display device such as a liquid crystal display or an organic electroluminescence display. The display unit 15 can include a display and a drive circuit that drives the display.

The general-purpose printer driver 16 will be described. The general-purpose printer driver 16 is an OS standard printer driver that is included in or attached to the OS included in the control program. For example, the general-purpose printer driver 16 is a standard printer driver for Windows (registered trademark, the same applies below) OS. The general-purpose printer driver 16 can be a program capable of controlling the printers to perform printing for various types of printers. The general-purpose printer driver 16 can also be referred to as an OS general-purpose printing program or a general-purpose printing program.

The general-purpose printer driver 16 is a driver that uses a general-purpose protocol for searching for a printer and for printing. For example, the general-purpose printer driver 16 uses mDNS/DNS-SD for searching for a printer and uses IPP for printing in the printer. Here, DNS is an abbreviation for domain name system. mDNS abbreviation for multicast DNS. DNS-SD is an abbreviation for DNS service discovery. IPP is an abbreviation for internet printing protocol.

As can be seen from these examples, the general-purpose printer driver 16 can be, for example, an IPP class driver. IPP is an example of a standard protocol for controlling management and printing of the printer. The IPP acquires and controls printer information using hypertext transfer protocol (HTTP) POST requests and responses. In the IPP, the printer can be set and a state of the printer can be acquired. Here, secure communication can be performed by using HTTP secure (HTTPS) instead of the HTTP.

The vendor auxiliary App 17 will be described. The vendor auxiliary App 17 is an application program for assisting the general-purpose printer driver 16 and is used to expand functions of the general-purpose printer driver 16. Therefore, the general-purpose printer driver 16 can have functions of starting the vendor auxiliary App 17 and transmitting a printing job to the vendor auxiliary App 17. The vendor auxiliary App 17 can be, for example, a print support application (PSA). One printing job refers to instructions for a series of operations for printing one or a plurality of printed matters and includes the printing data and printing settings. When printing a plurality of printed matters, one printing job can refer to instructions of a series of operations for printing printed matters having the same printing content.

The vendor auxiliary App 17 can be a program for assisting the general-purpose printer driver 16 and causing a computer to execute printing control suitable for performances of a target printer, that is, printing control for supporting a function unique to the printer. Here, the computer refers to the terminal device 10 or the control unit 11. In the embodiment, a printing function using an image difference is included as a function unique to the printer. When acquiring the printing job from the general-purpose printer driver 16, the vendor auxiliary App 17 can convert the printing job such that a designated printer can perform printing using a function unique to the printer. The conversion of the printing job can include conversion of the printing data.

The vendor auxiliary App 17 is an application program provided by, for example, a printer vendor. The vendor auxiliary App 17 can be provided to the user of the terminal device 10 by being disclosed in, for example, an application store of an OS provider. Alternatively, the vendor auxiliary App 17 can be provided to the user by being included in the OS or attached to the OS.

The vendor auxiliary App 17 includes a printing control program to be described later. That is, the printing control program can also be implemented as, for example, a PSA. The printing control program is a program for causing a computer to execute acquisition processing, difference processing, and first instruction processing to be described later. Here, the computer also refers to the terminal device 10 or the control unit 11.

In the acquisition processing, the printing data is acquired from the general-purpose printer driver 16. The vendor auxiliary App 17 can acquire the printing data from the general-purpose printer driver 16 through inter-process communication. The printing data can be, for example, data for printing converted by the general-purpose printer driver 16 from a file to be printed that is designated by the user. However, the printing data is not limited to data described in a page description language and may be image data. The subsequent processing can be performed regardless of whether the printing data is the image data or page description language data by matching a data type with the printing data acquired in the acquisition processing or by converting the printing data as necessary to match the data type.

In the difference processing, difference data between first printing data that is previously acquired printing data and second printing data that is newly acquired printing data is calculated. To perform such processing, the previously acquired first printing data may be stored in the storage unit 12. The first printing data can be, for example, printing data for printing a first page of a certain file to be printed. In this case, the second printing data can be printing data for printing a second page of the file to be printed. The second printing data can be printing data of a third page and subsequent pages of the file to be printed. When one page of the file to be printed is printed on one medium, first, second, and third sheets of the media correspond to the first page, the second page, and the third page, respectively.

In the difference processing, the difference data may be calculated by a calculation method in which a data amount of the difference data is smallest among a plurality of predetermined calculation methods. The selection of the calculation method may be determined for each file to be printed or may be determined by comparing actually calculated results.

The plurality of predetermined calculation methods include, for example, the following first and second calculation methods and are not limited thereto. The first calculation method is a method of calculating a difference by comparing, as a whole, two images that are difference calculation targets. The second calculation method is a method of scanning one pixel at a time and calculating a difference. For example, a calculation method obtained by synthesizing the first calculation method and the second calculation method as appropriate may be included in the above-described plurality of calculation methods. A calculation method completely different from these methods may be used.

The first printing data may be printing data of an n-th sheet of a certain file to be printed, and the second printing data may be printing data for one or more sheets of an (n+1)-th sheet and subsequent pages of the file to be printed.

In the first instruction processing, the difference data is transmitted to the printer, and the printer is caused to perform printing based on synthesized data obtained by synthesizing the first printing data with the difference data. As pre-stage processing of the first instruction processing, the vendor auxiliary App 17 performs processing of transmitting the first printing data and performing printing based on the first printing data. An instruction for such printing can be generated by generating a printing job including the first printing data and transmitting the printing job. The vendor auxiliary App 17 may directly transmit the printing job to the printer or may transmit the printing job to the printer via the general-purpose printer driver 16.

An instruction for printing in the first instruction processing can be generated by generating a printing job including the difference data and a setting for synthesizing the first printing data and the difference data, and transmitting the printing job. The vendor auxiliary App 17 may directly transmit the printing job to the printer or may transmit the printing job to the printer via the general-purpose printer driver 16. To be compatible with this printing job, the printer can synthesize such first printing data and difference data, that is, can synthesize the image data. A printer, such as the printer A (31), that receives the instruction in the first instruction processing, that is, the generated printing job, executes the printing job to generate the printing data by synthesizing the first printing data and the difference data, thereby printing the printing data as images. Printed matters printed based on the printing data generated by the synthesis are the same as printed matters printed based on the second printing data.

The printing control program according to the embodiment has been mainly described above, and in other words, the embodiment can provide a printed matter production method including the acquisition processing, the difference processing, and the first instruction processing described above to produce a printed matter. In other words, the printed matter production method includes the acquisition processing difference processing described above, and printing processing of transmitting the difference data to the printer, performing, by the printer, printing based on the synthesized data obtained by synthesizing the first printing data with the difference data, and producing the printed matter.

In other words, the printing system 100 includes the terminal device exemplified by the terminal device 10 and a printer connected to the terminal device and exemplified by the printer A (31). The terminal device includes the general-purpose printer driver 16 and the following acquisition processing unit, difference processing unit, and first instruction processing unit.

The acquisition processing unit acquires the printing data from the general-purpose printer driver 16. The difference processing unit calculates the difference data between the first printing data that is previously acquired printing data and the second printing data that is newly acquired printing data. The first instruction processing unit transmits the difference data to the printer, and causes the printer to perform printing based on the synthesized data obtained by synthesizing the first printing data with the difference data. Of course, the printer can synthesize such first printing data and difference data, that is, can synthesize the image data. The first instruction processing unit may be simply referred to as an instruction processing unit. The first instruction processing unit may also be referred to as a printing instruction because the first instruction processing unit instructions to print.

### Effects of Embodiment

Before describing a more specific example of the printing processing according to the embodiment, effects of the embodiment will be described.

As described above, in the printing system 100, the printing control program exemplified by the vendor auxiliary App 17 instructs the printer to perform printing based on the synthesized data obtained by synthesizing the difference data with the first printing data as a printing instruction to the printer. Therefore, according to the embodiment, it can be said that it is possible to perform printing using the image difference that cannot be handled only by the general-purpose printer driver 16 in the printing processing using the general-purpose printer driver 16. That is, according to the embodiment, it is possible to perform printing using an image difference to reduce an amount of data transmitted to the printer in an environment in which printing processing using a general-purpose printer driver is performed. For example, according to the embodiment, a function of performing printing using the image difference can be implemented by a printing control program for assisting the general-purpose printer driver 16 such as the PSA.

### Specific Example of Printing Processing according to Embodiment

In the following description, an example will be described in which printing is performed by the printer A (31) among the printers included in the printing system 100. The same applies when printing is performed using the printer B (32) or the printer C (33). In the following description, an example will be described in which the vendor auxiliary App 17 is implemented with the printing control program for performing the acquisition processing, the difference processing, and the first instruction processing described above.

In the printing processing according to the embodiment, as described above, to perform printing using the image difference, printing in which the difference data is synthesized with the first printing data is performed. The printing processing can include generation processing of generating a printing job for causing the printer A (31) to perform printing in which additional data that is data of a difference image indicated by the difference data is added to the first printing data at an addition position to perform printing accompanied by the synthesis described above. The generation processing may be included in the first instruction processing. To perform printing corresponding to such a printing job, the printer A (31) has a function of storing graphics. Due to this function, the printer A (31) includes a storage unit. To perform the generation processing, for example, the vendor auxiliary App 17 can have functions as described below.

The vendor auxiliary App 17 has a function of acquiring a difference between an image on the first page and an image on the second page at the time of printing a plurality of pages and setting a location of the difference as the addition position and the difference image. Specifically, the vendor auxiliary App 17 has a function of transmitting the difference data to the general-purpose printer driver 16 or directly to the printer A (31) as the printing instruction. The difference data includes, for example, information indicating a position such as coordinates to which the difference image indicated by the difference data is applied such that a position at which the difference data is synthesized with the first printing data can be determined on a side of the printer A (31).

Here, an example will be described in which the difference data includes the additional data indicating the difference image and the addition position in the first printing data. The vendor auxiliary App 17 in this example has a function of transmitting the first printing data as background image data, the addition position, and the additional data to the general-purpose printer driver 16 or directly to the printer A (31) as the printing instruction. The vendor auxiliary App 17 may transmit a setting for storing the first printing data in the printer A (31) as a part of the printing instruction. As a part of the printing instruction, the vendor auxiliary App 17 may transmit an instruction to print or store and print the additional data superimposed on the background image indicated by the first printing data stored in the printer A (31) at the addition position.

The vendor auxiliary App 17 may have a function of transmitting, as the printing instruction, the addition position and the additional data to the general-purpose printer driver 16 or directly to the printer A (31) in a stage after the first printing data is already transmitted. Even in this case, as a part of the printing instruction, the vendor auxiliary App 17 may transmit the instruction to print or store and print the additional data superimposed on the background image indicated by the first printing data stored in the printer A (31) at the addition position.

The setting and the instruction may be included in one printing job, or may be transmitted to the general-purpose printer driver 16 or directly to the printer A (31) by the vendor auxiliary App 17 as a printing job for each medium. An example has been described in which the difference data includes the additional data indicating the difference image and the addition position to the first printing data, and the difference data may be only the printing data in the same coordinate range as the first printing data.

### Example of Generation Processing

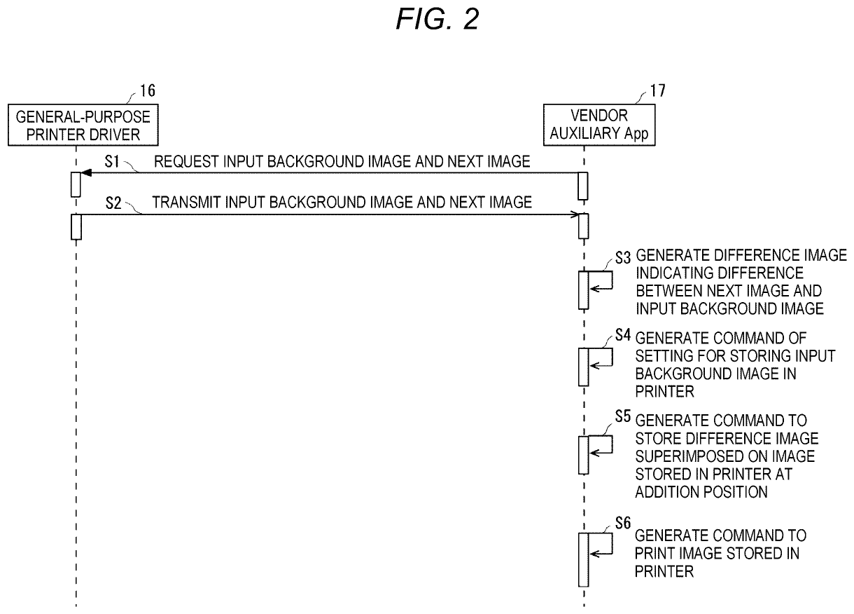

Next, an example of the generation processing included in the printing processing according to the embodiment will be described with reference to FIG. 2. FIG. 2 is a sequence diagram illustrating an example of generation processing in the printing system 100 in FIG. 1. For the sake of simplicity, an example in which two images are printed will be described here.

First, the user activates the vendor auxiliary App 17 directly or via the general-purpose printer driver 16, and instructs the start of the printing processing using the image difference. In response to this instruction, the vendor auxiliary App 17 requests the general-purpose printer driver 16 to transmit an input background image and a next image (step S1). The input background image is a first image, and indicates an image indicated by the first printing data described above. The next image is a second image, and indicates an image indicated by the second printing data described above.

In response to this transmission request, the general-purpose printer driver 16 transmits the input background image and the next image to the vendor auxiliary App 17 (step S2).

Next, the vendor auxiliary App 17 generates a difference image indicating a difference between the next image and the input background image (step S3). In step S3, the vendor auxiliary App 17 also calculates the addition position that is a position of the difference image with respect to the input background image.

Next, the vendor auxiliary App 17 generates a command of a setting for storing data of the input background image in the printer A (31) (step S4). Next, the vendor auxiliary App 17 generates a command to store the difference image superimposed on the image stored in the printer at the addition position and adds the command after the command generated in step S4 (step S5).

Then, the vendor auxiliary App 17 generates a command to print the image stored in the printer A (31) and adds the command after the command generated in step S5 (step S6). The vendor auxiliary App 17 may transmit a printing job formed by the command generated in step S6 to the printer A (31) directly or via the general-purpose printer driver 16.

### First Example of Printing Processing

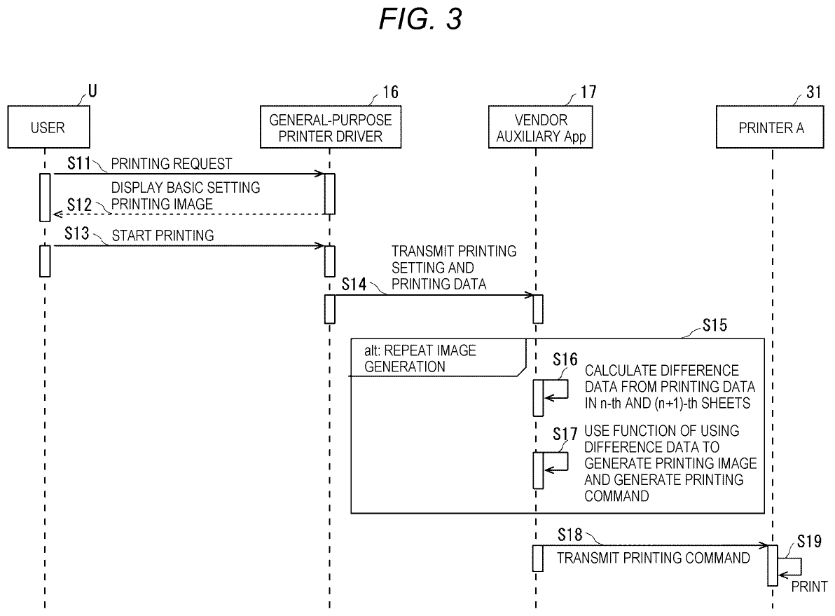

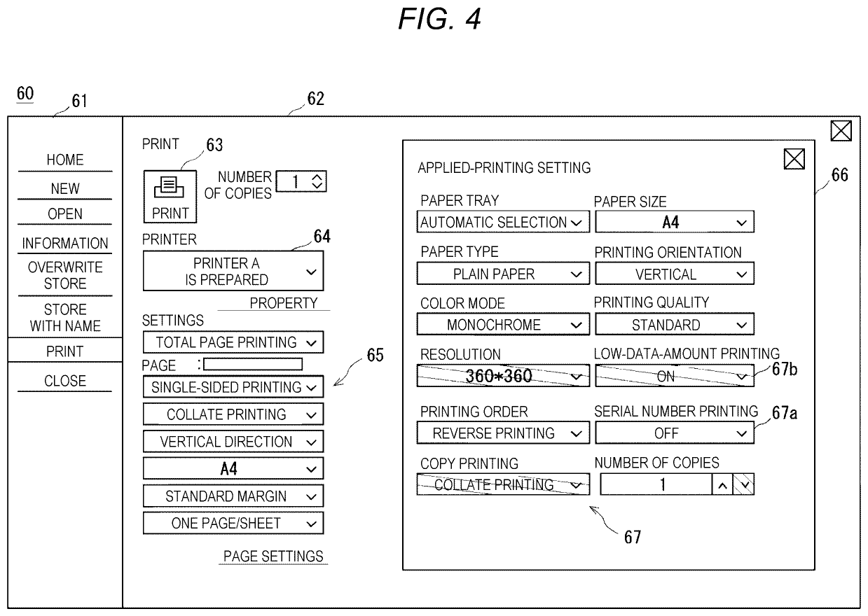

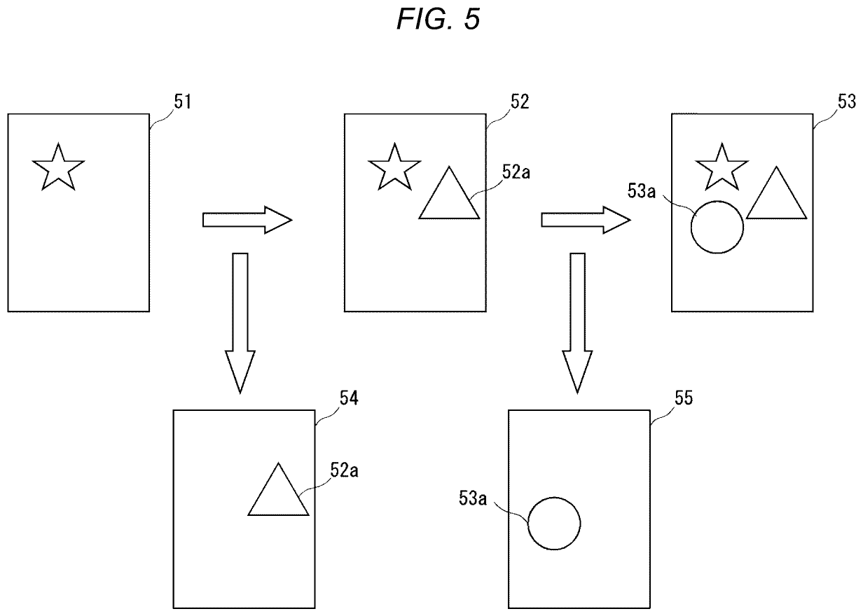

A first example of the printing processing according to the embodiment will be described with reference to FIGS. 3 to 5. Even in the following printing processing, the generation processing described in FIG. 2 is also performed. FIG. 3 is a sequence diagram illustrating a first example of the printing processing in the printing system 100 in FIG. 1, that is, a first example of low-data-amount printing processing. FIG. 4 is a diagram illustrating an example of a UI image displayed in the low-data-amount printing processing in FIG. 3. FIG. 5 is a schematic diagram illustrating an example of difference processing in the low-data-amount printing processing in FIG. 3.

First, a user U starts an application program for, for example, starting and editing a file to be printed such as a document file. Then, the user U performs, by the operation unit 14, an operation of selecting the printer A (31) in the printing setting of the file to be printed and selecting a property. By such an operation, the general-purpose printer driver 16 receives a printing request (step S11). Alternatively, when the user U performs an operation of selecting and printing the file to be printed with the operation unit 14, the general-purpose printer driver 16 receives a predetermined printing request for printing by the printer A (31).

In response to such a printing request from the user U, the general-purpose printer driver 16 displays a basic printing setting image as the UI image (step S12). The basic printing setting image is a UI image for receiving a user operation for performing a basic setting that is a setting basic for printing. For example, the basic printing setting image can be an image of a portion excluding an applied-printing setting image 66 in the UI image 60 illustrated in FIG. 4, or an image of a portion excluding the applied-printing setting image 66 and an application function selection image 61. Hereinafter, the basic printing setting image will be referred to as a basic printing setting image 62. For example, the basic printing setting image 62 can include a printing button 63 for starting printing, a pull-down menu 64 for selecting a printer, and a basic setting item group 65 for performing various basic settings. In the basic printing setting image 62, the number of copies can also be set. The application function selection image 61 includes buttons for performing printing, and the basic printing setting image 62 in step S12 may be displayed in a stage in which the buttons for performing printing are displayed. The application function selection image 61 can include buttons for selecting a basic function such as a button for opening a file and a button for overwriting and storing.

The basic setting item group 65 can include, for example, selection of a page on which printing is to be performed, selection of single-sided printing or double-sided printing, selection of performing collate printing or performing printing in units of pages, and selection of performing vertical printing or lateral printing. The basic setting item group 65 can further include selection of a sheet, selection of a margin size, and the number of pages to be aggregated on one sheet.

The basic printing setting image 62 can further include a property button 64a for setting a property of a printer selected in the pull-down menu 64, in this example the printer A (31), and a page setting button 65a for setting page details. When the property button 64a is selected, the applied-printing setting image 66 is displayed. When the page setting button 65a is selected, a printing setting image unique to the application program for starting the file to be printed can be displayed, though not illustrated.

Here, an example will be described in which the property button 64a is selected in a state in which the printer A (31) is selected in the basic printing setting image 62 and low-data-amount printing is designated in an applied-printing setting image.

When the user U selects the property button 64a by the operation unit 14, the user U requests the general-purpose printer driver 16 to display the applied-printing setting image. In response to this request, the general-purpose printer driver 16 requests the vendor auxiliary App 17 for an applied-printing setting item that can be set as a vendor function. The vendor auxiliary App 17 transmits a predetermined applied-printing setting item to the general-purpose printer driver 16 as an answer to this request. In response to this answer, the general-purpose printer driver 16 display, on the display unit 15, the UI image 60 in which the applied-printing setting items that can be set as the vendor function is embedded in a predetermined UI image.

Accordingly, the UI image 60 includes the applied-printing setting image 66 including the applied-printing setting item 67. However, it is also possible to display the applied-printing setting image 66 as a UI image separate from the basic printing setting image 62. Instead of the general-purpose printer driver 16, the vendor auxiliary App 17 itself may display the UI image 60 on the display unit 15.

The applied-printing setting image 66 can include items that can be set in the basic printing setting image 62 as the applied-printing setting item 67. In the first example described here, the applied-printing setting item 67 includes a pull-down menu 67a for switching on and off of the low-data-amount printing. The applied-printing setting item 67 can further include a pull-down menu 67a for switching on and off of serial number printing. As illustrated in FIG. 4, when the pull-down menu 67b of the low-data-amount printing is turned on, a pull-down menu of an item that cannot be selected correspondingly, for example, the pull-down menu 67a, may be grayed out. When a pull-down menu of a certain item is turned on, a pull-down menu of an item that cannot be selected correspondingly may be grayed out, not limited to the pull-down menu 67b. The applied-printing setting image 66 may include a close button 68 for closing the UI image itself. Other menus such as radio buttons may be used instead of the pull-down menu.

Then, for example, when the UI image 60 is displayed, the user U inputs, with the operation unit 14, printing settings of printing conditions such as the paper tray, the paper size, and the paper type, and a printing setting for turning on the pull-down menu 67b of the low-data-amount printing.

When the pull-down menu 67b of the low-data-amount printing is turned on, the user U selects the close button 68 or directly selects the printing button 63. Based on this selection, the general-purpose printer driver 16 receives the printing start request from the user U (step S13).

In response to this request, the general-purpose printer driver 16 transmits the printing settings and the printing data to the vendor auxiliary App 17 (step S14). Here, when the printing data is data for performing printing of two or more sheets, the vendor auxiliary App 17 may request the printing data of each sheet from the general-purpose printer driver 16 and receive the printing data. In any processing, as described in step S2 in FIG. 2, the vendor auxiliary App 17 acquires the first printing data indicating the input background image and the second printing data indicating the next image from the general-purpose printer driver 16.

Next, in response to the printing setting and the printing data, the vendor auxiliary App 17 performs processing of repeating the image generation (step S15). Step S15 includes step S16 and step S17 to be described later.

In step S16, the vendor auxiliary App 17 compares the first printing data, which is the printing data of the first page, and the second printing data, which is the printing data of the second page, and for a difference location from the first printing data which is a comparison source in the second printing data, calculates the addition position, which is a position of the difference location, and the difference image. In step S16, the same calculation is performed for printing on subsequent media such as the second sheet and the third sheet. In this way, in step S16, the vendor auxiliary App 17 calculates the difference data including the addition position and the difference image from the printing data of the n-th sheet and the (n+1)-th sheet.

In step S17, the vendor auxiliary App 17 uses a function of using the difference data to generate the printing image, and generates the printing data. Specifically, the vendor auxiliary App 17 generates the printing command to fit the difference image indicated by the difference data to the input background image indicated by the first printing data at the addition position. Here, the vendor auxiliary App 17 generates the printing command as described in steps S3 to S6 in FIG. 2.

In step S15, steps S16 and S17 are repeated until there is no second printing data in step S16. In step S16, the vendor auxiliary App 17 may generate a plurality of printing commands by individually generating the printing commands for the n-th sheet and the (n+1)-th sheet while increasing n. Alternatively, the vendor auxiliary App 17 may generate the printing command for the n-th sheet and the (n+1)-th sheet as one printing command in a form of adding commands while increasing n.

Next, the vendor auxiliary App 17 transmits the generated printing command to the printer A (31) as the printing job (step S18). The communication between the vendor auxiliary App 17 and the printer A (31) may be performed according to a vendor-extended IPP protocol or other SNMP or vendor-specific protocols. SNMP is an abbreviation for simple network management protocol.

An example has been described in which the printing command is transmitted directly to the printer A (31) in step S18 without going through the general-purpose printer driver 16. The vendor auxiliary App 17 may transmit the printing command to the general-purpose printer driver 16. In this case, in response to this printing command, the general-purpose printer driver 16 may transmit the printing command to the printer A (31).

The printer A (31) receives the printing command as the printing job and performs printing (step S19). When printing the image of the (n+1)-th sheet, the printer A (31) can perform printing by synthesizing the image of the (n+1)-th sheet with the image of the n-th sheet that is previously generated and stored.

A specific example of such printing is described with reference to FIG. 5 along with an example of the difference processing. As described above, the low-data-amount printing is printing using the image difference to reduce an amount of communication data. In the low-data-amount printing, the printing data a is generated by transmitting the first sheet to the printer A (31) as it is, transmitting only an image difference position after the first sheet, and partially replacing the printing image on a main body side, thereby reducing an amount of transmitted data compared to when images of all pages are transmitted.

An example will be described in which the user U wants to print an image 51 of the first sheet, an image 52 of the second sheet, and an image 53 of the third sheet illustrated in FIG. 5. The three images 51 to 53 are images of consecutive pages of one document file. A data amount when the three images 51 to 53 are transmitted from the terminal device 10 side to the printer A (31) as they are is equivalent to data amount for three A4 sheets, assuming each image is an A4 size image.

However, in the embodiment, printing using the difference is performed, and the amount of data can be reduced. That is, in the embodiment, the vendor auxiliary App 17 calculates the difference image and the addition position and transmits information about the difference image and the addition position to the printer A (31). Therefore, in the printing command generated by the vendor auxiliary App 17, an amount of transmitted data is reduced as follows.

Since there is no comparison target for the image 51 of the first sheet, data on the image is included in the printing command as it is. For the image 52 of the second sheet, as indicated by a difference image 54, an object 52a is added to the image 51. Therefore, data on an image of the object 52a and an addition position thereof are included in the printing command. For the image 53 of the third sheet, as indicated by a difference image 55, an object 53a is added to the image 52. Therefore, data on an image of the object 53a and an addition position thereof are included in the printing command.

More specifically, the vendor auxiliary App 17 generates the following printing command. For the image 51 of the first sheet, the printing command includes a command to transmit and store data and to cause the printer A (31) to print the stored image.

For the image 52 of the second sheet, the printing command includes a command to transmit data of the image of the object 52a indicated by the difference image 54 and a drawing position thereof and to cause the printer A (31) to perform overwrite storage on the image stored in the printer A (31) according to the drawing position. For the image 52 of the second sheet, the printing command further includes a command to print the overwritten and stored image.

For the image 53 of the third sheet, the printing command includes a command to transmit data of the image of the object 53a indicated by the difference image 55 and a drawing position thereof and to cause the printer A (31) to perform overwrite storage on the image stored in the printer A (31) according to the drawing position. For the image 53 of the third sheet, the printing command further includes a command to print the overwritten and stored image.

By performing such low-data-amount printing, the amount of data can be reduced as compared with the amount of data when the three images 51 to 53 are transmitted from the terminal device 10 side to the printer A (31) as they are.

As described above, the first printing data and the second printing data can be printing data of consecutive pages of the same document file.

As described above, in the first example of the low-data-amount printing processing, the printing system 100 can perform the low-data-amount printing with the reduced amount of data transmitted to the printer by introducing the vendor auxiliary App 17 using the image difference, as an example of printing using the image difference. Therefore, in the printing system 100, even when the user U does not prepare a difference image between a plurality of images, it is possible to perform printing with a small amount of communication data by storing graphics in the printer. Since the low-data-amount printing processing is processing of synthesizing a change from the previous image and performing printing using the difference, the low-data-amount printing processing may also be referred to as variable low-data-amount printing.

### Second Example of Printing Processing

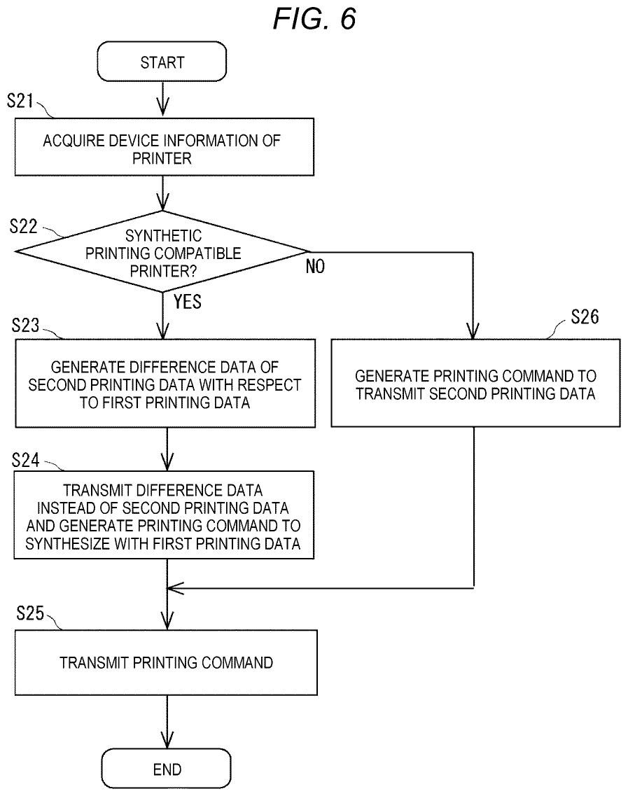

A second example of the printing processing according to the embodiment will be described with reference to FIG. 6. FIG. 6 is a flowchart illustrating a second example of the low-data-amount printing processing in the printing system 100 in FIG. 1. In the following description, the second example will be described, focusing on differences from the first example, but various examples from the first example can also be applied.

The vendor auxiliary App 17 in the second example is a program that causes a computer exemplified by the terminal device 10 or the control unit 11 to further execute the following determination processing and second instruction processing.

In the determination processing, it is determined whether the printer A (31) is a first device capable of synthesizing the difference data or a second device incapable of synthesizing the difference data. The determination as to whether it is compatible with such synthesis printing can be, for example, a determination as to whether the printer A (31) is compatible with graphics storage.

Information indicating whether the printer A (31) has a graphic storage function can be held in advance by the vendor auxiliary App 17. Alternatively, the vendor auxiliary App 17 can have a function of acquiring device information of the printer A (31) and determining whether the printer A (31) has a graphic storage function based on the device information. For example, the vendor auxiliary App 17 can acquire the IPP Attribute from the general-purpose printer driver 16 and perform this determination with reference to the IPP Attribute. More specifically, the vendor auxiliary App 17 can obtain, as the IPP Attribute, for example, a Printer Description Attribute, which is a description value of the printer A (31), and use the Printer Description Attribute for the determination.

The vendor auxiliary App 17 in the second example causes the computer to execute the first instruction processing when it is determined that the printer A (31) is the first device. That is, the vendor auxiliary App 17 executes the first instruction processing of transmitting the difference data and not transmitting the second printing data only when it is determined that the printer A (31) is the first device.

In the second instruction processing, when it is determined that the printer A (31) is the second device, the difference data is not transmitted and the second printing data is transmitted to the printer A (31), and printing based on the second printing data is performed. The printing command for causing the printer A (31) to perform printing based on the second printing data in the second instruction processing can be generated in the same manner as the printing command for causing the printer A (31) to perform printing based on the first printing data.

The vendor auxiliary App 17 having such a configuration can low-data-amount printing processing as follows. That is, the vendor auxiliary App 17 acquires the device information of the printer A (31) via the general-purpose printer driver 16 (step S21). Next, the vendor auxiliary App 17 determines whether the printer A (31) is a printer compatible with the synthesis printing based on the acquired device information (step S22).

If YES in step S22, the vendor auxiliary App 17 generates the difference data of the second printing data with respect to the first printing data (step S23). Next, the vendor auxiliary App 17 transmits the difference data instead of the second printing data, and generates a printing command for synthesizing the first printing data with the difference data (step S24). Next, the vendor auxiliary App 17 transmits the printing command generated in step S24 to the printer A (31) directly or via the general-purpose printer driver 16 (step S25), and ends the processing.

On the other hand, if NO in step S22, the vendor auxiliary App 17 transmits the second printing data and generates a printing command for performing printing based on the second printing data (step S26). Next, the vendor auxiliary App 17 transmits the printing command generated in step S26 to the printer A (31) directly or via the general-purpose printer driver 16 (step S25), and ends the processing.

As described above, in the second example, since it is determined whether the printer A (31) is compatible with the synthesis printing to perform the processing, the printer A (31) can perform necessary printing regardless of whether the printer A (31) can perform the synthesis printing.

### Other Modifications

The present disclosure is not limited to the embodiment described above and can be changed as appropriate without departing from the gist of the present disclosure. For example, the system configuration of the printing system, the configurations of the devices implementing the system, the configurations of the programs included in each device, the processing procedures of each device, and the like are not limited to the exemplified ones. The printing system may also use a network configuration in which a terminal device is connected to a printer via a print server.

For example, the present disclosure is not limited to comparing printing data of consecutive pages of the same document file to calculate the difference. If past printing data can be referenced by both the terminal device 10 and a printer on which printing is to be performed, the past printing data may be the same document file or different document files, and a difference can be calculated by comparing with the past printing data. In this case, it is desirable for the user U to designate, via the UI image 60, which piece of printing data is to be compared to calculate the difference.

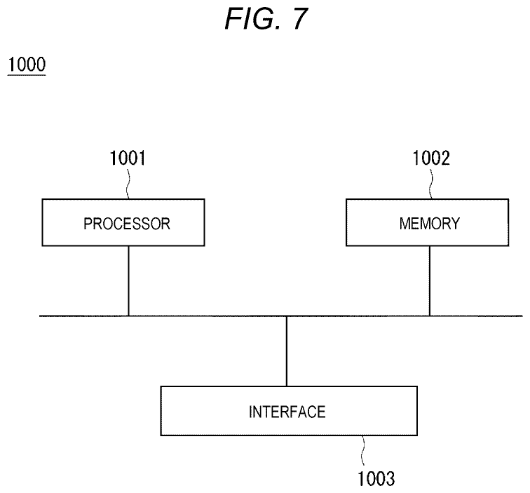

Each device included in the printing system according to the embodiment described above may have, for example, the following hardware configuration. Here, each device includes the terminal device and the printers in the example illustrated in FIG. 1. FIG. 7 is a diagram illustrating an example of a hardware configuration of a device.

A device 1000 illustrated in FIG. 7 can include a processor 1001, a memory 1002, and an interface 1003. The interface 1003 can include, for example, a communication interface or an interface with an input and output device, which are necessary depending on the device.

The processor 1001 may be, for example, a CPU, a GPU, or a micro processor unit (MPU) also referred to as a microprocessor. The processor 1001 may include plurality of processors. The memory 1002 is implemented by, for example, a combination of a volatile memory and a nonvolatile memory. Functions of each device are implemented by the processor 1001 reading a program stored in the memory 1002 and executing the program while exchanging necessary information via the interface 1003.

The program described above includes a command group (or software codes) for causing a computer to perform one or more functions described in the embodiment when the program is read in the computer. The program may be stored in a non-transitory computer-readable medium or a tangible storage medium. Not as a limitation but as an example, the computer-readable medium or the tangible storage medium includes a random-access memory (RAM), a read-only memory (ROM), a flash memory, a solid-state drive (SSD), or another memory technology. Not as a limitation but as an example, the computer-readable medium or the tangible storage medium includes a CD-ROM, a digital versatile disc (DVD), a Blu-ray (registered trademark) disk, or another optical disc storage, a magnetic cassette, a magnetic tape, a magnetic disk storage, or another magnetic storage device. The program may be transmitted on a transitory computer-readable medium or a communication medium. Not as a limitation but as an example, the transitory computer-readable medium or the communication medium includes a propagation signal of an electric, optical, acoustic, or another form. The program is included in a program product.

The present disclosure is described with reference to the above-described embodiment. The present disclosure is not limited only to the configuration in the above-described embodiment, and it goes without saying that the present disclosure includes various variations, modifications, and combinations that can be achieved by those skilled in the art within the scope of the disclosure in the claims of the present application. For example, the invention of the printed matter production method can be interpreted as an invention of a print method.

What is claimed is:

1. A non-transitory computer-readable storage medium storing a printing control program, the printing control program causing a computer to execute:
acquisition processing of acquiring printing data from a general-purpose printer driver;
difference processing of calculating difference data between first printing data that is previously acquired printing data and second printing data that is newly acquired printing data; and
first instruction processing of transmitting the difference data to a printer and causing the printer to perform printing based on synthesized data obtained by synthesizing the first printing data with the difference data.

2. The non-transitory computer-readable storage medium storing the printing control program according to claim 1, wherein
the printing control program is a print support application.

3. The non-transitory computer-readable storage medium storing the printing control program according to claim 1, the printing control program causing the computer to further execute:
determination processing of determining whether the printer is a first device capable of synthesizing the difference data or a second device incapable of synthesizing the difference data; and
second instruction processing of transmitting the second printing data to the printer without transmitting the difference data and causing the printer to perform printing based on the second printing data when it is determined that the printer is the second device, wherein
the first instruction processing is processing executed by the computer when it is determined that the printer is the first device.

4. The non-transitory computer-readable storage medium storing the printing control program according to claim 1, wherein
the first printing data and the second printing data are printing data of consecutive pages of the same document file.

5. The non-transitory computer-readable storage medium storing the printing control program according to claim 1, wherein
in the difference processing, the difference data is calculated with a calculation method in which a data amount of the difference data is smallest among a plurality of predetermined calculation methods.

6. A printing system comprising:
a printer; and
a terminal device, wherein
the terminal device includes
a general-purpose printer driver,
an acquisition processing unit configured to acquire printing data from the general-purpose printer driver,
a difference processing unit configured to calculate difference data between first printing data that is previously acquired printing data and second printing data that is newly acquired printing data, and
an instruction processing unit configured to transmit the difference data to the printer and cause the printer to perform printing based on synthesized data obtained by synthesizing the first printing data with the difference data.

7. A printed matter production method comprising:
acquisition processing of acquiring printing data from a general-purpose printer driver;
difference processing of calculating difference data between first printing data that is previously acquired printing data and second printing data that is newly acquired printing data; and
printing processing of transmitting the difference data to a printer and performing, by the printer, printing based on synthesized data obtained by synthesizing the first printing data with the difference data to produce a printed matter.
